(19) United States
(12) Patent Application Publication
(10) Pub. No.: US 2016/0039461 A1
(43) Pub. Date: Feb. 11, 2016

(54) VEHICLE FRAME STRUCTURE

(71) Applicant: TOYOTA JIDOSHA KABUSHIKI KAISHA, Toyota-shi (JP)

(72) Inventor: Hiroyuki KUROKAWA, Nisshin-shi (JP)

(73) Assignee: TOYOTA JIDOSHA KABUSHIKI KAISHA, Toyota-shi (JP)

(21) Appl. No.: 14/820,800

(22) Filed: Aug. 7, 2015

(30) Foreign Application Priority Data
Aug. 11, 2014 (JP) 2014-163740
Oct. 3, 2014 (JP) 2014-204571
Jun. 8, 2015 (JP) 2015-116072

(51) Int. Cl. B62D 21/07; B62D 21/11

(52) U.S. Cl. CPC B62D 21/07; B62D 21/11

(57) ABSTRACT

A vehicle frame structure includes: a pair of left and right upper members that have a vehicle front-rear direction inside end portion joined to an upper section of a panel configuring a vehicle cabin, and that extend toward the vehicle front-rear direction outer side; a pair of left and right lower members that have a vehicle front-rear direction inside end portion joined to a lower section of the panel, and that extend upward toward the vehicle front-rear direction outer side; and a pair of left and right joining members that join vehicle front-rear direction outside end portions of the upper members to respective vehicle front-rear direction outside end portions of the lower members.

### CROSS-REFERENCE TO RELATED APPLICATIONS

This application is based on and claims priority under 35 USC 119 from Japanese Patent Applications No. 2014-163740 filed on Aug. 11, 2014, No. 2014-204571 filed on Oct. 3, 2014, and No. 2015-116072 filed on Jun. 8, 2015, the disclosures of which are incorporated by reference herein.

### BACKGROUND

1. Technical Field

The present invention relates to a vehicle frame structure.

2. Related Art

Vehicle body structures are known in which front end portions of rear side upper members extending toward the vehicle front side are disposed at rear portion upper sides of respective rear wheel arches, and front end portions of rear side lower members extending toward the vehicle front lower side are disposed at rear portion lower sides of the respective rear wheel arches (see, for example Japanese Patent Application Laid-Open (JP-A) No. 2010-188973).

However, there is still room for improvement of a structure in which load input to lower members is reduced, by cancelling out at least some of the load input to the lower members, such as the rear side lower members, using load input to upper members, such as the rear side upper members.

### SUMMARY

The present invention therefore provides a vehicle frame structure capable of reducing load input to one of upper members or lower members, by cancelling out at least some of the load input to the one of the upper members or the lower members using load input to the other of the upper members or the lower members.

One aspect of the present invention is a vehicle frame structure including: a pair of left and right upper members that have a vehicle front-rear direction inside end portion joined to an upper section of a panel configuring a vehicle cabin, and that extend toward the vehicle front-rear direction outer side; a pair of left and right lower members that have a vehicle front-rear direction inside end portion joined to a lower section of the panel, and that extend upward toward the vehicle front-rear direction outer side; and a pair of left and right joining members that join vehicle front-rear direction outside end portions of the upper members to respective vehicle front-rear direction outside end portions of the lower members.

In the present aspect, the vehicle front-rear direction outside end portions of the pair of left and right upper members, whose vehicle front-rear direction inside end portions are joined to the upper section side of the panel configuring the vehicle cabin and that extend toward the vehicle front-rear direction outer side, and the vehicle front-rear direction outside end portions of the pair of left and right lower members, whose vehicle front-rear direction inside end portions are joined to the lower section side of the panel and that extend upward toward the vehicle front-rear direction outer side, are joined together by the pair of left and right joining members. Thus, at least some of a load input to one of the upper members or the lower members may be cancelled out by load input to the other of the upper members or the lower members, thereby reducing the load input to the one of the upper members or the lower members.

The present aspect may further include a cross member that extends along the vehicle width direction, and that couples together the pair of left and right joining members.

In the above configuration, the joining members are coupled together by the cross member extending along the vehicle width direction. Thus, load input to one of the left or right upper members, or load input to one of the left or right lower members, may also be transmitted and distributed to the other of the left or right upper members, or the other of the left or right lower members, respectively.

In the present aspect, each of the pair of left and right upper members may include a suspension support section that supports a suspension.

In the above configuration, the suspension support section that supports the suspension is provided to the upper member. Thus, at least some of a load input to the upper member from the suspension may be cancelled out and reduced by load input to the lower member.

In the present aspect, each of the pair of left and right lower members may include a power unit support section that supports a power unit.

In the above configuration, the power unit support section that supports the power unit is provided to the lower member. Thus, at least some of a load input to the lower member from the power unit may be cancelled out and reduced by load input to the upper member. Thus, the power unit can be stably supported by the lower member.

The present aspect may further include a support member that supports a bumper reinforcement extending along the vehicle width direction, wherein a vehicle front-rear direction inside end portion of the support member is attached at a location at one of the pair of left and right lower members at which the power unit support section is provided.

In the above configuration, the vehicle front-rear direction inside end portion of the support member supporting the bumper reinforcement is attached at the location of the lower member at which the power unit support section is provided. Thus, the location of the lower member at which the power unit support section is provided may be efficiently reinforced.

In the present aspect, each of the pair of left and right upper members may include a groove that extends along the vehicle front-rear direction at a wall portion thereof that is facing the vehicle width direction outer side.

In the above configuration, the groove that extends along the vehicle front-rear direction is formed at the wall portion of the upper member facing the vehicle width direction outer side. Thus, the upper member can be utilized as a slide rail in cases in which a sliding door is provided, thereby achieving a reduction in the number of components.

The present aspect may further include a pair of left and right coupling members, that each have a vehicle front-rear direction inside end portion joined to the panel further to a vehicle upper side than the vehicle front-rear direction inside end portion of each of the pair of left and right lower members, and that each have a vehicle front-rear direction outside end portion that is joined to each of the pair of left and right lower members.

In the above configuration, the vehicle front-rear direction inside end portion of each coupling member is joined to the panel, and the vehicle front-rear direction outside end portion of each coupling member is joined to the respective lower member. Thus, the panel and the lower members are more firmly joined by the coupling members, and the lower members may be prevented from buckling in the event of a collision of the vehicle.

The present aspect may further include a first lower cross member that extends along the vehicle width direction and that couples together the pair of left and right lower members; and a second lower cross member that extends along the vehicle width direction and that couples together the pair of left and right coupling members.

In the above configuration, the lower members are coupled together by the first lower cross member, and the coupling members are coupled together by the second lower cross member. This prevents the lower members and the coupling members from tilting over toward the vehicle width direction outer side or inner side during a collision of the vehicle.

In the present aspect, the pair of left and right lower members, the pair of left and right coupling members, the first lower cross member and the second lower cross member may be configured to accommodate a fuel tank at the vehicle width direction inner side of the pair of left and right lower members and the pair of left and right coupling members, and at the vehicle front-rear direction inner side of the first lower cross member and the second lower cross member.

In the above configuration, the fuel tank is disposed further toward the vehicle width direction inner side than the lower members and the coupling members, and further toward the vehicle front-rear direction inner side than the first lower cross member and the second lower cross member. Namely, the fuel tank is disposed in a strong region surrounded by plural members. Thus, the fuel tank may be protected during a collision of the vehicle.

In the present aspect, each of the pair of left and right lower members may include a first bent portion that bulges downward toward the vehicle front-rear direction outer side; and the vehicle frame structure may further include a mount member that includes a second bent portion that bulges upward toward the vehicle front-rear direction inner side, a vehicle front-rear direction inside end portion of the mount member being coupled to one of the pair of left and right lower members at a location that is at the vehicle front-rear direction inner side of the first bent portion, and a vehicle front-rear direction outside end portion of the mount member being coupled to the one of the pair of left and right lower members at a location that at the vehicle front-rear direction outer side of the first bent portion.

In the above configuration, each of the lower members that includes the first bent portion bulging downward toward the vehicle front-rear direction outer side is coupled to the mount member that includes the second bent portion bulging upward toward the vehicle front-rear direction inner side and that is facing the first bent portion. Accordingly, the first bent portion of the lower member may be reinforced by the mount member.

In the present aspect, the second bent portion of the mount member may be configured to have a side portion of a power unit directly or indirectly attached thereto.

In the above configuration, a side portion of a power unit is directly or indirectly attached to the second bent portion of the mount member. Therefore, while a load is input to the second bent portion of the mount member from the vehicle upper side due to the power unit, a cancelling moment for the load is generated at the mount member. Accordingly, the power unit may be even more stably supported by the mount member.

### BRIEF DESCRIPTION OF THE DRAWINGS

Exemplary embodiments will be described in detail based on the following figures, wherein:

FIG. 1 is a perspective view illustrating a vehicle frame structure according to a first exemplary embodiment;

FIG. 2 is a side view illustrating the vehicle frame structure according to the first exemplary embodiment;

FIG. 3 is a plan view illustrating the vehicle frame structure according to the first exemplary embodiment;

FIG. 4 is a cross-section of a lower member configuring the vehicle frame structure according to the first exemplary embodiment;

FIG. 5 is a side view illustrating a first modified example of the vehicle frame structure according to the first exemplary embodiment;

FIG. 6 is a side view illustrating a second modified example of the vehicle frame structure according to the first exemplary embodiment;

FIG. 7 is a perspective view illustrating a vehicle frame structure according to a second exemplary embodiment;

FIG. 8 is a perspective view illustrating an enlarged portion of the vehicle frame structure according to the second exemplary embodiment;

FIG. 9 is a back view illustrating a vehicle frame structure according to the second exemplary embodiment;

FIG. 10 is a side view illustrating a vehicle frame structure according to the second exemplary embodiment;

FIG. 11 is a side view illustrating a vehicle frame structure according to a third exemplary embodiment;

FIG. 12 is a side view illustrating a main portion of the vehicle frame structure according to the third exemplary embodiment; and

FIG. 13 is a perspective view illustrating a main portion of the vehicle frame structure according to the third exemplary embodiment.

### DETAILED DESCRIPTION

Detailed explanation follows regarding exemplary embodiments, based on the drawings. Note that for ease of explanation, in each of the drawings the arrow UP indicates the vehicle upward direction, the arrow FR indicates the vehicle front direction, and the arrow LH indicates the vehicle left direction. Moreover, in the following explanation unless specifically indicated, reference to the front-rear, up-down, and left-right directions may be understood to refer to the vehicle front-rear direction, the vehicle up-down direction, and the vehicle left-right direction (vehicle width direction). A vehicle frame structure 10 according to the present exemplary embodiment may be applied to a front section or a rear section of a vehicle 12, and explanation follows regarding application to the rear section of the vehicle 12 as an example.

### First Exemplary Embodiment

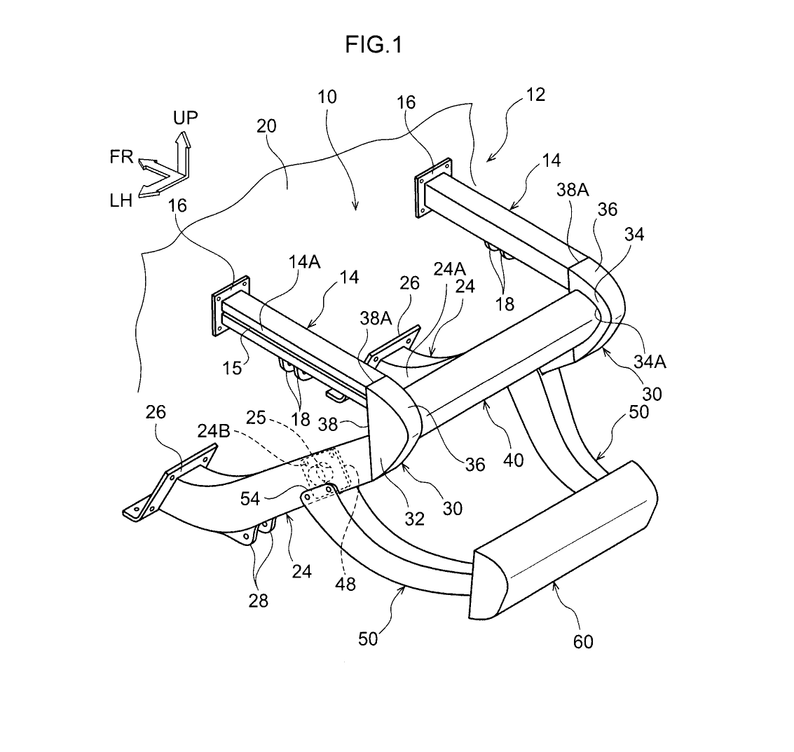

Explanation first follows regarding the vehicle frame structure 10 according to the first exemplary embodiment. As illustrated in FIG. 1 to FIG. 3, a pair of left and right rear side member uppers (hereafter referred to as “upper members”) 14, each extending straight toward the vehicle rear side (vehicle front-rear direction outer side), are disposed at the rear section of the vehicle 12. Each upper member 14 is formed in a rectangular closed cross-section profile by extrusion forming a lightweight metal material, such as aluminum, with a uniform cross-section, thereby configuring a vehicle frame member with high rigidity and strength.

A flat plate shaped flange 16 is fixed (welded) to a front end portion (vehicle front-rear direction inside end portion) of each upper member 14, and the flanges 16 are respectively attached to both left and right sides at an upper section of a rear panel 20 by fastening using bolts. The rear panel 20 is a vehicle frame member with high rigidity and strength that configures a rear wall of a vehicle cabin (not illustrated in the drawings), and is formed of carbon fiber reinforced plastic (CFRP), metal, or the like.

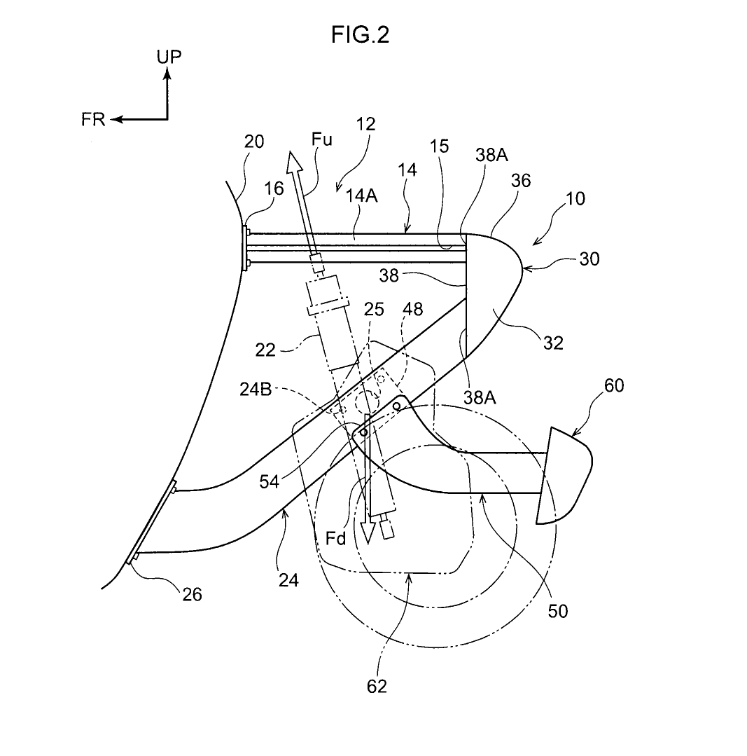

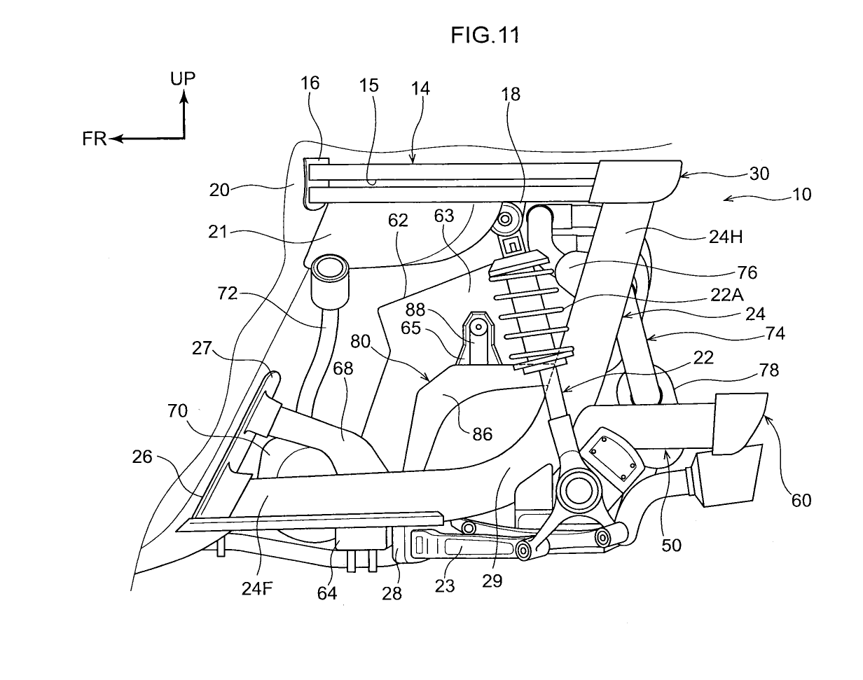

Upper brackets 18 (see FIG. 1), each serving as a suspension support section for attaching a shock absorber 22A (see FIG. 11) or the like of a suspension 22 (see FIG. 2), are disposed at a lower face of a length direction partway portion of each upper member 14. Note that the length direction partway portions of each upper member 14, provided with the upper brackets 18, may be coupled together and reinforced by an upper cross member (not illustrated in the drawings) extending along the vehicle width direction. The upper cross member may also be formed in a rectangular closed cross-section profile by extrusion forming a lightweight metal material, such as aluminum, with a uniform cross-section.

In side view viewed along the vehicle width direction, a pair of left and right rear side member lowers (hereafter referred to as “lower members”) 24, each extending straight toward the vehicle rear upper side (upward toward the vehicle front-rear direction outer side), are disposed at the rear section of the vehicle 12 to the vehicle lower side of the respective upper members 14. Each lower member 24 is formed in a rectangular closed cross-section profile by extrusion forming a lightweight metal material, such as aluminum, with a uniform cross-section, thereby configuring a vehicle frame member with high rigidity and strength.

A substantially flat plate shaped flange 26 is fixed (welded) to a front end portion (vehicle front-rear direction inside end portion) of each lower member 24, and the flanges 26 are respectively attached to both left and right sides at a lower section of the rear panel 20 by fastening using bolts. Note that the respective front end portions of the lower members 24 may be formed thicker than rear end portion sides thereof in order to increase the joint strength (rigidity) to the rear panel 20, and may curve slightly as progressing toward the vehicle front side in side view so as to facilitate joining to the rear panel 20.

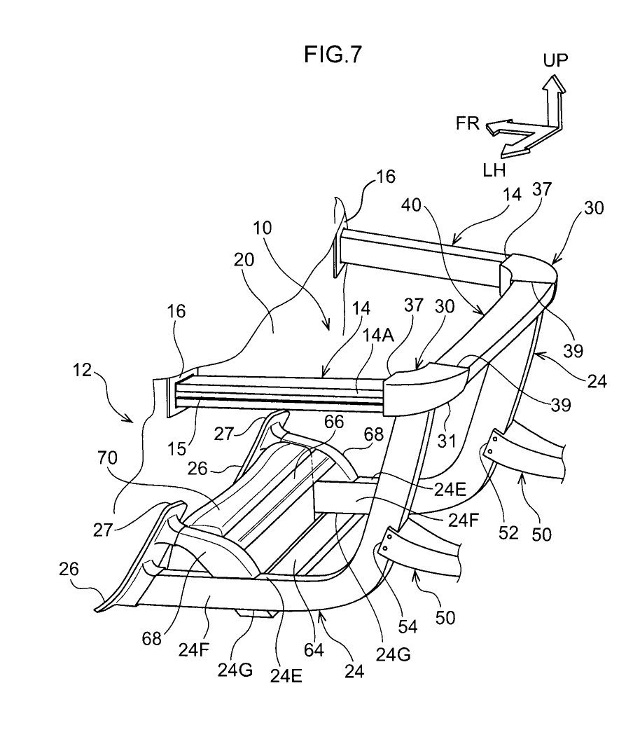

Respective lower brackets 28 (see FIG. 1), for attaching a lower arm 23 (see FIG. 11) of the suspension 22, are provided at a lower face of the front end portion of each lower member 24. Note that the front end portions of the lower members 24, provided with the lower brackets 28, may be coupled together and reinforced by a lower cross member 64 (see FIG. 7) extending along the vehicle width direction. The lower cross member 64 may also be formed in a rectangular closed cross-section profile by extrusion forming a lightweight metal material, such as aluminum, with a uniform cross-section.

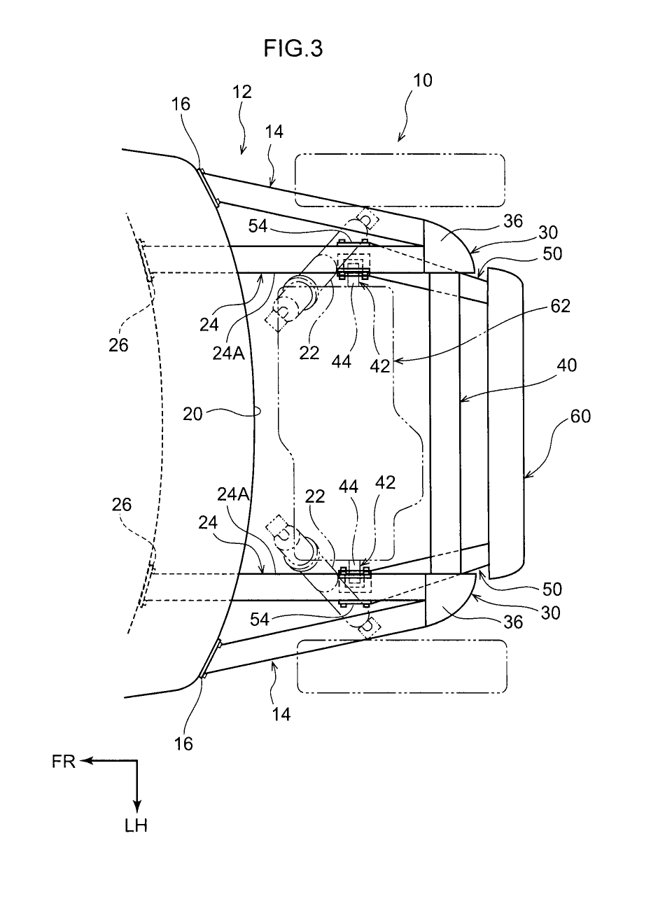

The cross-section area of each lower member 24 is formed larger than the cross-section area of each upper member 14. Namely, each lower member 24 is formed with a thicker rectangular closed cross-section profile than each upper member 14. The respective upper members 14 are disposed further to the vehicle width direction outer side than the respective lower members 24 (see FIG. 3). Each upper member 14 may be shaped so as to have curvature such that the vehicle rear side curves toward the vehicle width direction inner side in plan view, for the sake of styling or the like.

Rear end portions (vehicle front-rear direction outside end portions) of the respective upper members 14 are joined to the rear end portions (vehicle front-rear direction outside end portions) of the respective lower members 24 by a pair of left and right joining members 30. Each joining member 30 is formed in the shape of casing open toward the vehicle front side, using a lightweight metal material such as aluminum.

Specifically, each joining member 30 is configured by an outer wall 32 and an inner wall 34 that each have an apex facing toward the vehicle rear side and are substantially triangular shaped in side view, and a coupling wall 36 that couples the outer wall 32 and the inner wall 34 in the vehicle width direction and closes off the vehicle upper side and the vehicle rear side. Each joining member 30 is open at the vehicle front side. Namely, an opening 38 is formed at the vehicle front side of each joining member 30

The rear end portion of the upper member 14 and the rear end portion of the lower member 24 are thereby inserted inside the opening 38 of the respective joining member 30 from the vehicle front side and the vehicle front lower side, respectively, and are joined to an edge portion 38A of the opening 38 by arc welding or the like. The rear end portion of the upper member 14 and the rear end portion of the lower member 24 are thereby joined together by the respective joining member 30, and a truss structure (triangular frame) that is substantially triangular shaped in side view (a substantially right angled triangle with the respective lower member 24 as the hypotenuse in side view) and has left-right symmetry is formed by the rear panel 20, and the upper members 14 and the lower members 24.

The left and right joining members 30 are coupled together by a cross member 40 extending along the vehicle width direction. The cross member 40 is formed in a closed cross-section profile by extrusion forming a lightweight metal material, such as aluminum, with a uniform cross-section, and is formed in a substantially triangular shape in cross-section view, such that the external appearance is substantially similar, for example, to the outer wall 32 and the inner wall 34 of each joining member 30.

Recessed portions 34A (see FIG. 1), into which the respective left and right end portions of the cross member 40 are inserted (fitted), are formed at the inner walls 34 of the joining members 30. Both left and right end portions of the cross member 40 are inserted (fitted) into the respective recessed portions 34A and joined to the respective joining members 30 by arc welding or the like, thereby coupling between the respective joining members 30.

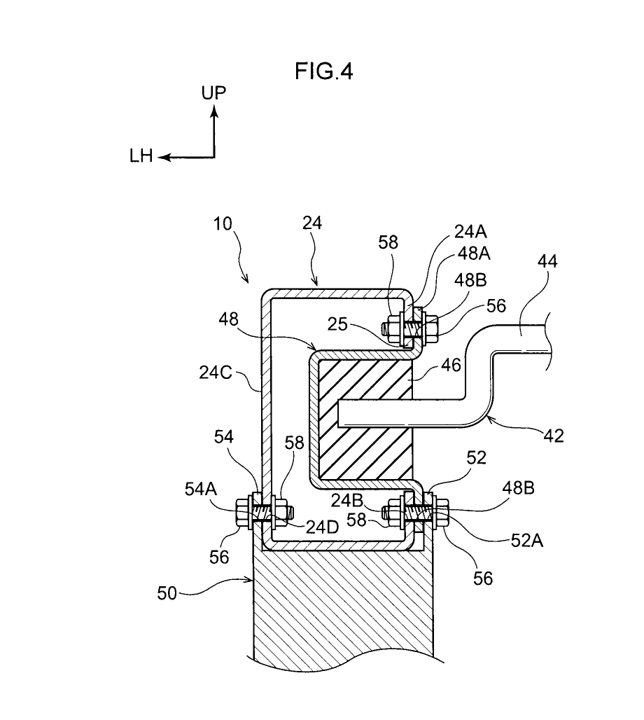

An opening 25, which is circular shaped in side view and serves as a power unit support section for supporting an engine mount 42, is formed at an inner wall 24A of each lower member 24, further toward the vehicle rear side than the lower bracket 28. Holes 24B, through which bolts 56 are inserted, are formed at the inner wall 24A at plural positions (for example four locations) at a peripheral edge of the opening 25, and weld nuts 58 are provided coaxially to the respective holes 24B at an inner face of the inner wall 24A (see FIG. 4).

As illustrated in FIG. 4, each engine mount 42 includes a metal circular column shaped support member 44 extending from the side of a power unit 62 including an engine (see FIG. 2 and FIG. 3) toward the vehicle width direction outer side, a rubber circular column shaped resilient member 46, with a vehicle width direction outside end portion of the support member 44 pierced through and fixed to a center portion (core portion) of the resilient member 46, and a cover member 48 with a substantially hat shaped cross-section profile and a bottomed circular cylinder shape that covers the resilient member 46.

The outer diameter of the cover member 48, excluding a flange 48A formed in a substantially rectangular shape, is substantially the same as the inner diameter of the opening 25, and holes 48B, through which the bolts 56 are inserted, are formed at respective corner portions of the flange 48A of the cover member 48. Thus, the cover member 48 is inserted into the opening 25, the respective holes 48B of the flange 48A are placed in communication (overlapped) with the respective holes 24B formed at the inner wall 24A, and the bolts 56 are inserted through the respective holes 48B, 24B, and screwed together with the weld nuts 58, thereby fixing the engine mount 42 to the lower member 24.

As illustrated in FIG. 1 to FIG. 3, front end portions of a pair of left and right extension members 50, serving as support members, are attached by fastening using bolts to lower face sides of the respective lower members 24 at locations at which the openings 25 are formed. Each extension member 50 is formed in a rectangular closed cross-section profile by extrusion forming a lightweight metal material, such as aluminum, with a uniform cross-section, and flanges 52, 54 formed at the front end portion thereof are fastened to the respective lower member 24 using bolts.

Specifically, as illustrated in FIG. 4, the flange 52, covering a lower portion of the flange 48A of the cover member 48 from the vehicle width direction inner side, is integrally formed at the vehicle width direction inner side of the front end portion of the respective extension member 50. The flange 52 is formed at a height that almost reaches the opening 25, and the length of the flange 52 along the length direction of the lower member 24 has a length of the diameter of the opening 25, or greater. Plural holes 52A, through which the bolts 56 are inserted, are formed (in two locations, for example) at the flange 52.

Thus, the holes 52A of the flange 52 are placed in communication with the respective holes 48B of the flange 48A, and the respective holes 24B formed at the inner wall 24A, and the bolts 56 are inserted through the respective holes 52A, 48B, 24B and screwed together with the weld nuts 58, thereby fastening the flange 52 of the extension member 50 to the respective lower member 24.

The flange 54, covering an outer wall 24C of the respective lower member 24 from the vehicle width direction outer side, is integrally formed at the vehicle width direction outer side of the front end portion of the respective extension member 50. The flange 54 is formed at substantially the same height as the flange 52, and the length of the flange 52 along the length direction of the lower member 24 has a length of the diameter of the opening 25 or greater. Plural holes 54A, through which bolts 56 are inserted, are formed (in two locations, for example) at the flange 54.

Plural (for example, two) holes 24D, through which the bolts 56 are inserted, are formed at the outer wall 24C of the respective lower member 24, and the holes 24D are formed at positions in communication with the respective holes 24B in the vehicle width direction (at the same position in side view). Weld nuts 58 are provided coaxially to the respective holes 24D at an inner face of the outer wall 24C of the lower member 24.

Thus, the holes 54A of the flange 54 are placed in communication with the respective holes 24D formed at the outer wall 24C, and the bolts 56 are inserted through the respective holes 54A, 24D and screwed together with the weld nuts 58, thereby fastening the flange 54 of the extension member 50 to the respective lower member 24.

Configuration is thereby such that the front end portion of each extension member 50 is fixed to the respective lower member 24, and the front end portion of the extension member 50 can efficiently reinforce (can prevent a reduction in strength of) the location of the lower member 24 at which the opening 25 is formed.

As illustrated in FIG. 1 to FIG. 3, rear bumper reinforcement 60 extending along the vehicle width direction spans across between rear end portions of the extension members 50. The rear bumper reinforcement 60 is also formed in a closed cross-section profile by extrusion forming a lightweight metal material, such as aluminum, with a uniform cross-section, and is joined to the rear end portions of the extension members 50 by arc welding or the like.

A groove 15, extending along the length direction of each upper member 14, is formed at an outer wall 14A, serving as a wall portion of the respective upper member 14 facing the vehicle width direction outer side. Forming the groove 15 to the outer wall 14A of the upper member 14 enables, for example, the upper member 14 to be utilized as a slide rail in cases in which a sliding door (not illustrated in the drawings) is provided, thereby enabling the number of components to be reduced.

Note that each of the upper members 14, the lower members 24, the cross member 40, the extension members 50, and the rear bumper reinforcement 60 is not limited to a configuration formed by extrusion forming a lightweight metal material with a uniform cross-section, and for example, may each be formed in a closed cross-section profile by joining together an outer panel and an inner panel, not illustrated in the drawings.

In particular, the front end portion of each lower member 24 provided with the lower brackets 28 may be formed thicker than the rear end portion side thereof, and formed curving slightly toward the vehicle front side in side view, and may therefore be formed in a closed cross-section profile by joining together an outer panel and an inner panel. Moreover, the rear bumper reinforcement 60 may be formed in a rectangular closed cross-section profile, in which one or plural partition walls (not illustrated in the drawings) are integrally formed inside the closed cross-section, in order to prevent cross-section deformation occurring due to the input of load.

Explanation follows regarding operation of the vehicle frame structure 10 according to the first exemplary embodiment, configured as described above.

As illustrated in FIG. 2, a load Fu toward the vehicle upper side is input to the upper members 14 from the shock absorbers 22A of the suspension 22 (see FIG. 11) or the like. A load Fd toward the vehicle lower side is input to the lower members 24 from the power unit 62.

The front end portions of the upper members 14 are joined to the rear panel 20, and the upper members 14 extend toward the vehicle rear side. The front end portions of the lower members 24 are joined to the rear panel 20, and the lower members 24 extend toward the vehicle rear upper side. The rear end portions of the upper members 14 and the rear end portions of the lower members 24 are joined together by the joining members 30.

Namely, a truss structure (triangular frame) that is substantially triangular shaped in side view (a substantially right angled triangular shape with the respective lower member 24 as the hypotenuse in side view) is formed by the rear panel 20, and each of the upper members 14 and each of the lower members 24, these being vehicle frame members. Thus, the upper members 14 and the lower members 24 have high rigidity and strength with respect to input load, and are not liable to deform.

This enables at least a part of the load Fd toward the vehicle lower side input to the lower members 24 from the power unit 62 to be cancelled out by the load Fu toward the vehicle upper side input to the upper members 14 from the shock absorbers 22A of the suspension 22 and the like. This enables the power unit 62 to be stably supported by the lower members 24.

Note that at least a part of the load Fu toward the vehicle upper side input to the upper members 14 from the shock absorbers 22A of the suspension 22 and the like can also be cancelled out by the load Fd toward the vehicle lower side input to the lower members 24 from the power unit 62. Namely, at least a part of the load input to one of the upper members 14 or the lower members 24 can be cancelled out by the load input to the other of the upper members 14 or the lower members 24, enabling the load input to the one of the upper members 14 or the lower members 24 to be reduced.

Further, the left and right joining members 30 are coupled together by the cross member 40. Thus, load input to one of the left or right upper member 14, or load input to one of the left or right lower member 24 can be transmitted and distributed to the other of the left or right upper member 14, or the other of the left or right lower member 24. This enables concentration of load at the one of the left or right upper member 14, or the one of the left or right lower member 24 to be reduced.

Collision load from the vehicle rear side is input to the rear bumper reinforcement 60 in the event of a rear end collision of the vehicle 12. When this occurs, the respective extension members 50 are efficiently crushed in their axial direction (vehicle front-rear direction), absorbing some of the collision load. Namely, each extension member 50 also functions as an energy absorption (crash box). Collision load that has not been fully absorbed by the respective extension members 50 is transmitted to the respective lower members 24.

As described above, the truss structure that is substantially triangular shaped in side view (a substantially right angled triangular shape with the respective lower member 24 as the hypotenuse in side view) is formed by the rear panel 20, and the upper members 14 and the lower members 24. The joining members 30, joining together the rear end portions of the upper members 14 and the rear end portions of the lower members 24, are coupled together by the cross member 40. Furthermore, the front end portions of the extension members 50 are fastened to the respective lower members 24 at the locations at which the openings 25 are formed.

Namely, the lower members 24 are efficiently reinforced by the respective extension members 50, thereby preventing a reduction in strength (rigidity) of the lower members 24. The lower members 24 are formed thicker (with a larger cross-section area) than the respective upper members 14. Thus, the lower members 24 are not liable to deform (have high rigidity and strength), and buckling (folding deformation) of the lower members 24 is suppressed or prevented, even when collision load is transmitted to the lower members 24.

Thus, the collision load transmitted to the lower members 24 is efficiently transmitted and distributed to the respective upper members 14 and the rear panel 20, and efficiently absorbed by the lower members 24, the upper members 14, and the rear panel 20. Namely, concentration of load at the lower members 24 and the upper members 14 can be reduced, and collision safety performance of the vehicle 12 can be secured, even when the lower members 24 and the upper members 14 are configured of a lightweight metal material such as aluminum that has a lower strength than sheet steel.

Moreover, there is no need to increase the plate thickness or to reinforce the upper members 14 or the lower members 24 using reinforcement (which would increase the number of components) (configuration is made simple), thereby enabling weight reduction of the vehicle 12 to be achieved. The manufacturing processes of the upper members 14 and the lower members 24 can be reduced, thereby enabling spending on equipment (manufacturing cost) to be reduced, and enabling the productivity of the upper members 14 and the lower members 24 to be improved.

The lower brackets 28, for attaching the lower arms 23 of the suspension 22, are provided at locations at which the lower cross member 64 couples together the lower members 24, and the upper brackets 18, for attaching the shock absorbers 22A of the suspension 22 and the like, are provided at locations at which the upper cross member couples together the upper members 14.

Providing the lower cross member 64 and the upper cross member thereby enables the supporting rigidity (endurance rigidity) of the lower members 24 and the upper members 14 with respect to load input from the lower arms 23, the shock absorbers 22A, and the like to be improved. This enables the steering stability performance of the vehicle 12 to be improved.

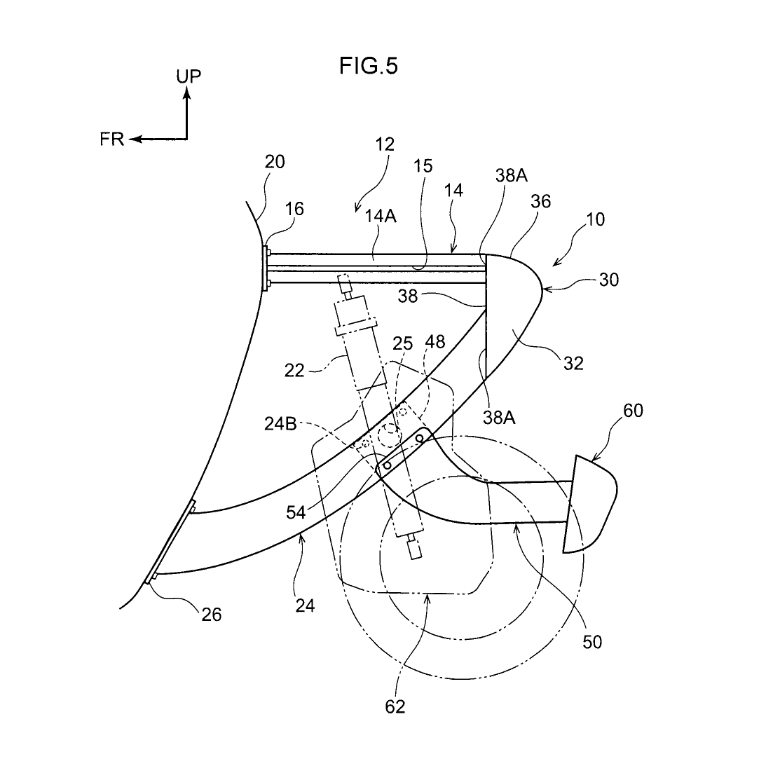

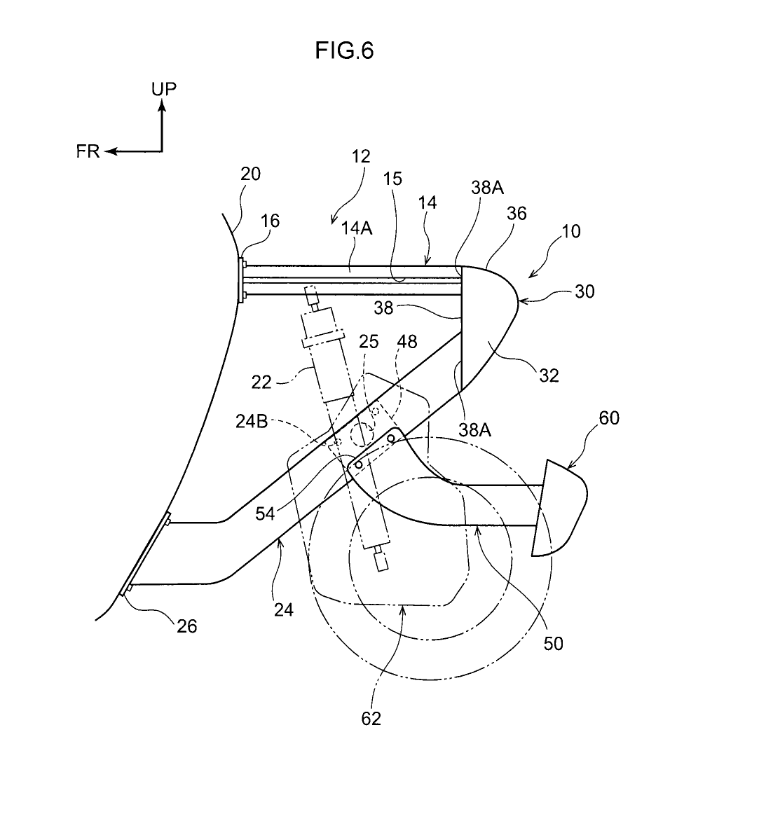

Note that the lower members 24 are not limited to a configuration formed in straight lines toward the vehicle rear upper side in side view, and as illustrated in the example in FIG. 5, the lower members 24 may each be formed in a curved shape curving toward the vehicle rear upper side in side view, depending on the specification of the suspension 22 and the power unit 62. Moreover, as illustrated in the example in FIG. 6, each lower member 24 may be formed in a bent shape including a location extending toward the vehicle rear side and a location extending toward the vehicle rear upper side in side view.

### Second Exemplary Embodiment

Explanation follows regarding a vehicle frame structure 10 according to a second exemplary embodiment. Note that similar components to those in the first exemplary embodiment are appended with the same reference numerals, and detailed explanation (including of common operation) is omitted.

As illustrated in FIG. 7, in the vehicle frame structure 10 according to the second exemplary embodiment, the shapes of joining members 30 and a cross member 40 differ from those in the first exemplary embodiment. Namely, each joining member 30 is formed in a substantially fan shape in plan view, and is formed in a rectangular closed cross-section profile open toward the vehicle front side and the vehicle width direction inner side. A rectangular recessed portion (not illustrated in the drawings) is formed at a lower wall 31 of each joining member 30. The cross member 40 is formed with a rectangular shaped cross-section.

The rear end portions of upper members 14 are inserted into and joined to respective openings 37 open toward the vehicle front side of the respective joining members 30, and the upper end portions of lower members 24 are inserted into (fitted together with) and joined to the respective recessed portions formed at the lower walls 31 of the joining members 30, such that a truss structure (triangular frame) that is substantially triangular shaped in side view and has left-right symmetry is formed by a rear panel 20, and the upper members 14 and the lower members 24.

Both left and right end portions of the cross member 40 are inserted into and joined to openings 39 open toward the vehicle width direction inner side of the joining members 30, such that the left and right joining members 30 are coupled together by the cross member 40. The vehicle frame structure 10 according to the second exemplary embodiment, including the joining members 30 and the cross member 40 configured as described above, enables similar operation and effects to be obtained as in the first exemplary embodiment above.

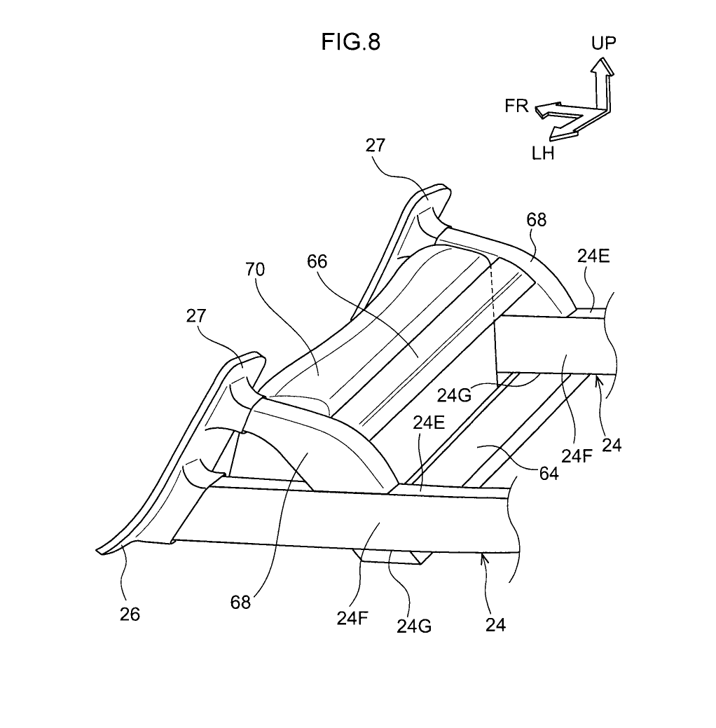

In the vehicle frame structure 10 according to the second exemplary embodiment, a location of each lower member 24 extending toward the vehicle rear side extends further than that illustrated in FIG. 6 (this location is referred to below as a “straight portion 24F”). As illustrated in FIG. 8, upper walls 24E of the straight portions 24F of the lower members 24 are coupled to vehicle up-down direction center portions of the rear panel 20 by a pair of left and right coupling members 68.

Specifically, an upper portion of a flange 26 fixed to the front end portion of the respective lower member 24 forms an upper side flange 27 extending toward the vehicle upper side as an integral unit, and each upper side flange 27 is attached by fastening by bolts to the rear panel 20 further to the vehicle lower side than flanges 16. A front end portion of the coupling member 68 is joined (welded) to the respective upper side flange 27.

Each coupling member 68 is formed by extrusion forming a lightweight metal material, such as aluminum, to form a rectangular closed cross-section profile with a smaller cross-section at a front end side than at a rear end side, configuring a vehicle frame member with high rigidity and strength. The front end portion of each coupling member 68 is joined to the rear panel 20 through the upper side flange 27, the coupling member 68 extends toward the vehicle rear lower side, and a rear end portion of each coupling member 68 is joined (welded) to the upper wall 24E of the straight portion 24F of the respective lower member 24.

This enables the rear panel 20 and the lower members 24 to be more firmly joined by the respective coupling members 68, and enables the rigidity and strength of the vehicle frame members, including the lower members 24, to be further improved. This enables buckling (plastic deformation) of the lower members 24 to be prevented in the event of a rear end collision of the vehicle 12.

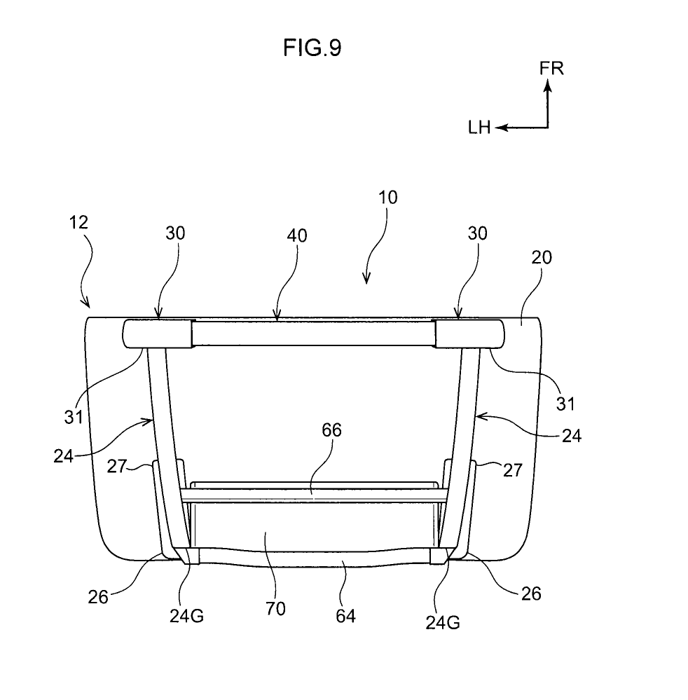

As illustrated in FIG. 7 to FIG. 9, lower walls 24G, directly below the respective upper walls 24E at which the rear end portions of the respective coupling members 68 are joined to the lower members 24, are coupled together by the lower cross member 64 serving as a first lower cross member extending along the vehicle width direction. Length direction substantially center portions of the coupling members 68 are coupled together by a coupling cross member 66 serving as a second cross member extending along the vehicle width direction.

Similar to the lower cross member 64, the coupling cross member 66 is formed in a rectangular closed cross-section profile by extrusion forming a lightweight metal material, such as aluminum, with a uniform cross-section, thereby configuring a vehicle frame member with high rigidity and strength. This enables the lower members 24 and the coupling members 68 to be prevented from tilting over toward the vehicle width direction outer side or inner side in the event of a rear end collision of the vehicle 12. Note that a mount bracket (not illustrated in the drawings) of an anti-roll rod structure supporting a front end portion of a power unit 62 is provided at a vehicle width direction center portion of the lower cross member 64.

As illustrated in FIG. 7 to FIG. 9, a fuel tank 70 is disposed further toward the vehicle width direction inner side than the lower members 24 and the coupling members 68, and further toward the vehicle front side than the lower cross member 64 and the coupling cross member 66 (between the lower cross member 64 and the coupling cross member 66, and the rear panel 20).

Specifically, the fuel tank 70 is formed with a substantially rectangular box shape with its length direction along the vehicle width direction, and is disposed at a strong region surrounded by the lower members 24 and the coupling members 68, the lower cross member 64 and the coupling cross member 66, and the rear panel 20. This enables the fuel tank 70 to be protected in the event of a rear end collision of the vehicle 12.

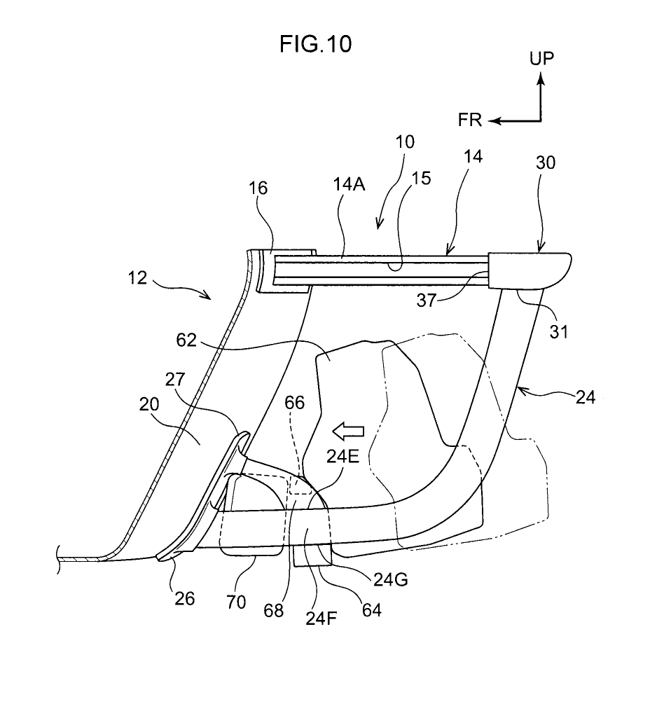

Namely, as illustrated in FIG. 10, in the event of a rear end collision of the vehicle 12, even if the power unit 62 moves toward the vehicle front side (the fuel tank 70 side), the movement of the power unit 62 toward the vehicle front side can be prevented by the coupling cross member 66 and the lower cross member 64.

This enables the power unit 62 to be prevented from colliding with the fuel tank 70 during a rear end collision of the vehicle 12, such that defects such as fuel leaks due to damage to the fuel tank 70 can be prevented from occurring. Moreover, the power unit 62 and the fuel tank 70 can be prevented from moving toward the rear panel 20 side, namely, the vehicle cabin side, thereby enabling the collision safety performance of the vehicle 12 to be improved.

### Third Exemplary Embodiment

Next, explanation follows regarding a vehicle frame structure 10 according to a third exemplary embodiment. Note that similar components to those in the first and second exemplary embodiments are appended with the same reference numerals, and detailed explanation (including that for common operations) is omitted.

As illustrated in FIG. 11, the vehicle frame structure 10 according to the third exemplary embodiment is configured similar to the second exemplary embodiment. Therefore, a truss structure (triangular frame) that is substantially triangular shaped in side view and has left-right symmetry is formed by a rear panel 20, the upper members 14 and the lower members 24, and similar operations and effects as the first exemplary embodiment are achieved.

Although not illustrated in FIG. 7 to FIG. 9, a fuel feed pipe 72 for feeding fuel into the fuel tank 70 is disposed at a vehicle width direction outside end portion (e.g., a left end portion) of the fuel tank 70, and extends upward toward the vehicle width direction outer side. An exhaust pipe 74 is connected to the power unit 62. The exhaust pipe 74 is disposed at the vehicle rear side of the power unit, and has a catalytic portion 76 that purifies exhaust gas by performing oxidation or reduction on toxic substances in the exhaust gas, and a muffler (or silencer) 78 at its partway portion.

A luggage box 21 is integrally formed at the upper portion of the rear panel 22, which projects out toward the vehicle rear side and extends in the vehicle width direction. The luggage box 21 is formed as a hollow shape opened at its vehicle interior side, and both left and right end portions thereof are fixed to inner walls of the left and right upper members 14 that face toward the vehicle width direction inner side by fastening using bolts.

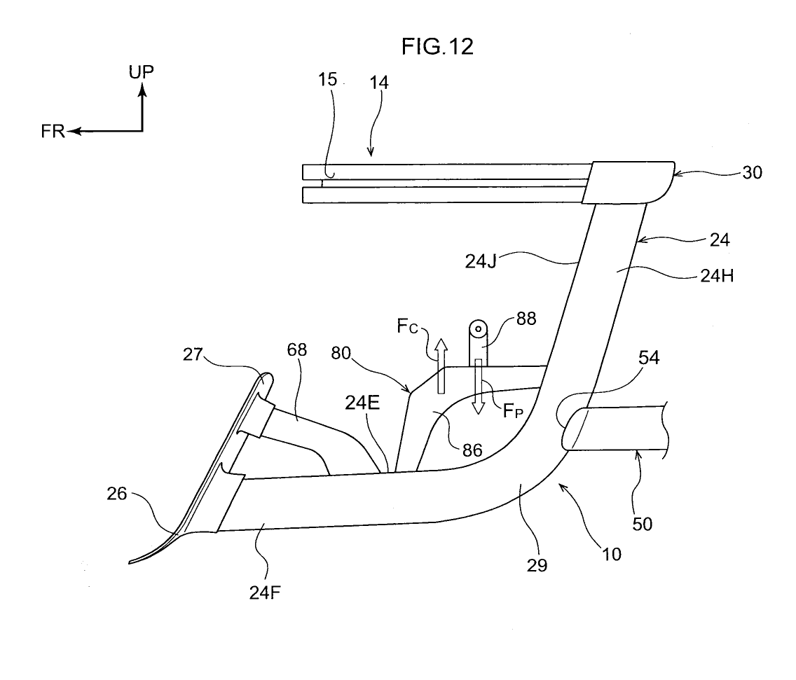

As illustrated in FIG. 11 and FIG. 12, each of the lower members 24 of the third exemplary embodiment is formed, as similar to the second exemplary embodiment, into a bent shape including a location extending toward the vehicle rear side (a front-rear straight portion 24F) and a location extending toward the vehicle rear upper side (hereinafter, referred to as an up-down straight portion 24H) in side view.

A border portion of the front-rear straight portion 24F and the up-down straight portion 24H of the lower member 24 is referred to as a first bent portion 29 that bulges downward toward the vehicle rear side (downward toward the vehicle front-rear direction outer side). Further, an arch-shaped mount member 80 that has a second bent portion 86 bulging upward toward the vehicle front side (upward toward the vehicle front-rear direction inner side) is coupled to each of the lower members 24 so as to face the first bent portion 29.

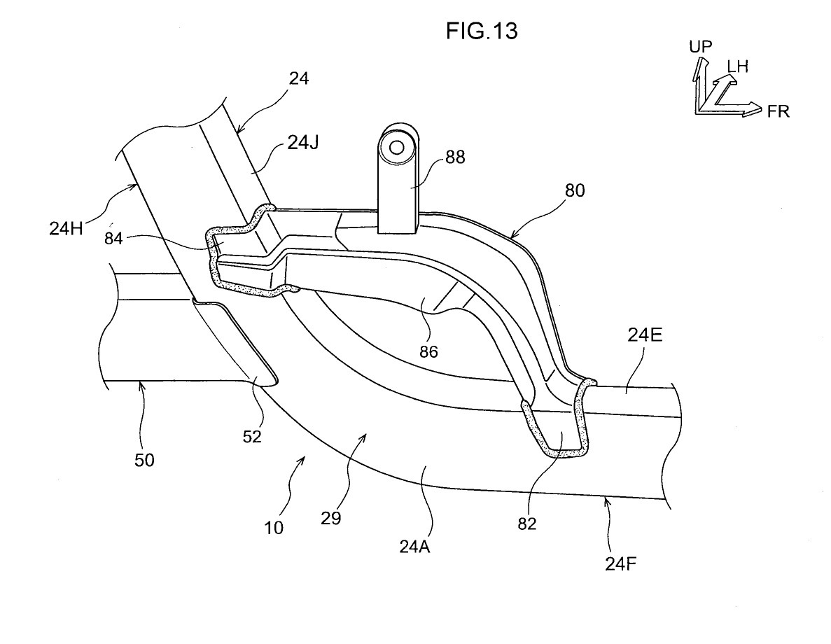

Specifically, as illustrated in FIG. 12 and FIG. 13, a front end portion (vehicle front-rear direction inside end portion) of the mount member 80 is configured as a substantially L-shaped front joining portion 82 that surface-contacts with an upper wall 24E and an inner wall 24A of the front-rear straight portion 24F at a location that is vehicle front side (vehicle front-rear direction inner side) than the first bent portion 29 and that is vehicle rear side than the coupling member 68. The peripheral portion of the front joining portion 82 is jointed to the upper wall 24E and the inner wall 24A by arc welding.

A rear end portion (vehicle front-rear direction outside end portion) of the mount member 80 is configured as a substantially L-shaped rear joining portion 84 that surface-contacts with a front wall 24J and the inner wall 24A of the front-rear straight portion 24F at a location that is vehicle upper side (vehicle front-rear direction outer side) than flange portions 52, 54 (the first bent portion 29). The peripheral portion of the rear joining portion 84 is jointed to the front wall 24J and the inner wall 24A by arc welding.

Thereby, the rigidity and strength of the first bent portion 29 of the lower member 24 can be reinforced by the mount member 80. That is, by arranging the first bent portion 29 of the lower member 24 and the second bent portion 86 of the mount member 80 to be opposing with each other in a substantially vehicle up-down direction, a frame structure that is resistant to deformation may be formed at the first bent portion 29 of the lower member 24.

Further, as illustrated in FIG. 11, a side portion 63 of the power unit 62 is indirectly attached to the second bent portion 86 of the mount member 80 via bracket 88 or the like. Specifically, as illustrated in FIG. 12 and FIG. 13, the bracket 88 that extends toward vehicle upper side is integrally formed at the second bent portion 86 (i.e., the substantially center portion) of the mount member 80. A bracket 65 (see FIG. 11) that is integrally formed at the side portion 63 of the power unit 62 coupled with the bracket 88 by fastening using bolts or the like.

Therefore, as illustrated in FIG. 12, load Fp is input by the power unit 62 acting from vehicle upper side toward vehicle down side to the second bent portion 86 (the substantially center portion) of the mount member 80. Since the second bent portion 86 of the mount member 80 is formed to be bulging upward toward the vehicle front side, a cancelling moment (a reaction force Fc acting toward the vehicle upper side) for the load Fp the can be generated.

That is, when the load Fp acting toward the vehicle down side is input to the second bent portion 86 of the mount member 80, a reaction force acting from the front joining portion 82 and the rear joining portion 84 toward the second bent portion 86 (the substantially center portion) is generated at the mount member 80. Thereby, the reaction force Fc (cancelling moment) acting toward the vehicle upper side can be generated, and the local rigidity and strength at the location of the mount member 80 where the bracket 88 is provided may be improved.

Accordingly, the power unit 62 may be even more stably supported by the mount member 80. In this regard, the side portion 63 of the power unit 62 may be directly attached to the second bent portion 86 of the mount member 80 without using the bracket 65 or 88. Even in such cases the power unit 62 may be even more stably supported by the mount member 80.

The vehicle frame structure 10 according to the above exemplary embodiments has be explained based on the drawings; however, the vehicle frame structure 10 according to the above exemplary embodiments is not limited to that illustrated in the drawings, and design modifications may be applied as appropriate within a range not departing from the spirit of the present invention. For example, the outer wall 14A of each upper member 14 may be configured without the groove 15.

Moreover, the power unit support section is not limited to the opening 25 formed at the inner wall 24A of the respective lower member 24, and may, for example, be configured by a bracket (not illustrated in the drawings) projecting out from an upper wall of the lower member 24. In such cases, the front end portion of the extension member 50 may not be attached to the location of the respective lower member 24 at which the power unit support section is provided.

Moreover, the cross member 40 coupling together the joining members 30 may be provided, as long as an upper cross member is provided to the upper members 14, the lower cross member 64 is provided to the lower members 24, or the like. Furthermore, the suspension support section may not be directly provided to the upper members 14, and the power unit support section may not be directly provided to the lower members 24.

Configuration is not limited to joining the flanges 16 of the upper members 14 and the flanges 26 of the lower members 24 to the rear panel 20 by fastening using bolts. In cases in which the rear panel 20 is made of metal, for example, the flanges 16 of the upper members 14 and the flanges 26 of the lower members 24 may be joined to the rear panel 20 using arc welding or the like.

Furthermore, instead of forming the recessed portions 34A into which both left and right end portions of the cross member 40 are inserted, and the recessed portions into which the upper end portions of the lower members 24 are inserted, openings (not illustrated in the drawings) for insertion thereof may be formed at the joining members 30. The upper members 14, the lower members 24, the extension members 50, and the like are not limited to configurations formed in a rectangular shaped cross-section, and may, for example, be formed in a circular shaped cross-section.

The extension members 50 are not limited to a configuration joined to the lower members 24 by fastening using bolts, and may be fastened (joined) to the lower members 24 using rivets or the like, not illustrated in the drawings. Alternatively, the extension members 50 may be joined to the lower members 24 using arc welding or the like.

Furthermore, the coupling members 68 may be omitted, as long as the rear panel 20 and the lower members 24 are firmly joined. The lower cross member 64 or the coupling cross member 66 may also be omitted, as long as the lower members 24 and the coupling members 68 are prevented from tilting over toward the vehicle width direction outer side or inner side during a rear end collision of the vehicle 12.

Moreover, configuration is not limited to one in which the fuel tank 70 is disposed further toward the vehicle width direction inner side than the lower members 24 and the coupling members 68, and further toward the vehicle front side than the lower cross member 64 and the coupling cross member 66 (between the lower cross member 64 and the coupling cross member 66, and the rear panel 20).

Further, the configuration of the second bent portion 86 of the mount member 80 is not limited to the bent shape illustrated in the drawings and may be, for example, formed by a smaller curved shape having a smaller curvature than that illustrated in the drawings. That is, the “bent portion” in the exemplary embodiment includes a curved portion.

What is claimed is:

1. A vehicle frame structure, comprising:
a pair of left and right upper members that have a vehicle front-rear direction inside end portion joined to an upper section of a panel configuring a vehicle cabin, and that extend toward the vehicle front-rear direction outer side;
a pair of left and right lower members that have a vehicle front-rear direction inside end portion joined to a lower section of the panel, and that extend upward toward the vehicle front-rear direction outer side; and
a pair of left and right joining members that join vehicle front-rear direction outside end portions of the upper members to respective vehicle front-rear direction outside end portions of the lower members.

2. The vehicle frame structure of claim 1, further comprising a cross member that extends along the vehicle width direction, and that couples together the pair of left and right joining members.

3. The vehicle frame structure of claim 1, wherein each of the pair of left and right upper members comprises a suspension support section that supports a suspension.

4. The vehicle frame structure of claim 1, wherein each of the pair of left and right lower members comprises a power unit support section that supports a power unit.

5. The vehicle frame structure of claim 4, further comprising a support member that supports a bumper reinforcement extending along the vehicle width direction, wherein
a vehicle front-rear direction inside end portion of the support member is attached at a location at one of the pair of left and right lower members at which the power unit support section is provided.

6. The vehicle frame structure of claim 1, wherein each of the pair of left and right upper members comprises a groove that extends along the vehicle front-rear direction at a wall portion thereof that is facing the vehicle width direction outer side.

7. The vehicle frame structure of claim 1, further comprising a pair of left and right coupling members, that each have a vehicle front-rear direction inside end portion joined to the panel further to a vehicle upper side than the vehicle front-rear direction inside end portion of each of the pair of left and right lower members, and that each have a vehicle front-rear direction outside end portion that is joined to each of the pair of left and right lower members.

8. The vehicle frame structure of claim 7, further comprising:
a first lower cross member that extends along the vehicle width direction and that couples together the pair of left and right lower members; and
a second lower cross member that extends along the vehicle width direction and that couples together the pair of left and right coupling members.

9. The vehicle frame structure of claim 8, wherein the pair of left and right lower members, the pair of left and right coupling members, the first lower cross member and the second lower cross member are configured to accommodate a fuel tank at the vehicle width direction inner side of the pair of left and right lower members and the pair of left and right coupling members, and at the vehicle front-rear direction inner side of the first lower cross member and the second lower cross member.

10. The vehicle frame structure of claim 1, wherein:
each of the pair of left and right lower members comprises a first bent portion that bulges downward toward the vehicle front-rear direction outer side; and
the vehicle frame structure further comprises a mount member that includes a second bent portion that bulges upward toward the vehicle front-rear direction inner side, a vehicle front-rear direction inside end portion of the mount member being coupled to one of the pair of left and right lower members at a location that is at the vehicle front-rear direction inner side of the first bent portion, and a vehicle front-rear direction outside end portion of the mount member being coupled to the one of the pair of left and right lower members at a location that at the vehicle front-rear direction outer side of the first bent portion.

11. The vehicle frame structure of claim 10, wherein the second bent portion of the mount member is configured to have a side portion of a power unit directly or indirectly attached thereto.
